(19) United States
(12) Patent Application Publication
(10) Pub. No.: US 2026/0316337 A1
(43) Pub. Date: Oct. 15, 2026

(54) PURE PHYSICAL SPHEROIDIZATION APPARATUS FOR POLYMER POWDER

(71) Applicant: Jiangxi University of Science and Technology, Nanchang City (CN)

(72) Inventors: Cijun Shuai, Nanchang City (CN); Fangwei Qi, Nanchang City (CN); Jun Zan, Nanchang City (CN); Xiong Shuai, Nanchang City (CN)

(21) Appl. No.: 19/641,149

(22) Filed: Apr. 7, 2026

(30) Foreign Application Priority Data
Apr. 10, 2025 (CN) 202510447684.8

(51) Int. Cl. B29B 9/12; B07B 1/04; B07B 7/08; B29B 9/10; B29B 13/02; B29B 13/04; B29L 31/00

(52) U.S. Cl. CPC B29B 9/12; B07B 1/04; B07B 7/08; B29B 9/10; B29B 13/021; B29B 13/04; B29B 2009/125; B29L 2031/756; B29L 2031/7734

(57) ABSTRACT

Provided is a pure physical spheroidization apparatus for polymer powder. The pure physical spheroidization apparatus includes a feeding system, a spheroidization system, a circulating cooling system and a microsphere classification and collection system. The feeding system includes a feeding-preheating synchronization unit, a high-speed jet powder spraying unit and a solid-gas sheath flow guide unit that are connected in sequence. The spheroidization system includes an elongated spheroidization furnace and a cooling hopper connected to an end of the spheroidization furnace. A showerhead-shaped dispersion mechanism communicating with an outlet of the solid-gas sheath flow guide unit is suspended from a top end of the spheroidization furnace. In a temperature descending manner, the spheroidization furnace is divided into at least three segments in an axial direction.

### CROSS-REFERENCE TO RELATED APPLICATION

This patent application claims the benefit and priority of Chinese Patent Application No. 2025104476848, entitled “PURE PHYSICAL SPHEROIDIZATION APPARATUS FOR POLYMER POWDER” filed on Apr. 10, 2025, the disclosure of which is incorporated by reference herein in its entirety as part of the present application.

### TECHNICAL FIELD

The present disclosure belongs to the field of polymer microsphere preparation, and in particular to a pure physical spheroidization apparatus for polymer powder.

### BACKGROUND

Polymer microspheres are micro-spherical particles made of polymer materials, which have become indispensable core materials in high-end technology products due to their unique spherical structure and excellent functional properties, particularly demonstrating enormous application potentials in fields such as biomedicine, 3D printing and chemical catalysis. For example, in the field of medical aesthetics, the spherical shape and smooth surface of the microspheres can reduce friction between cosmetics and the skin, enabling more uniform application and a smoother feel. In addition, the polymer microspheres can also fill the depression, thereby restoring the smoothness of the skin. In the pharmaceutical field, the microspheres are often used as drug carriers capable of encapsulating and protecting drugs, which can slowly release the drugs at the administration site in vivo, thereby extending the half-life and reducing toxic and side effects. In the field of 3D printing, microspheres with regular geometric morphology can significantly enhance flowability of powder, ensuring uniform powder spreading during 3D printing and reducing interlayer voids and printing defects. In the field of chemical catalysis, microspheres with a regular surface can form a uniform distribution interface of active sites, thereby reducing local differences in reactant concentration and improving catalytic reaction efficiency.

At present, preparation methods for polymer microspheres mainly include a solvent method and a mechanical method. The solvent method includes dissolving the polymer or monomer in an organic solvent, and then removing the solvent by using an appropriate method to form polymer powder. However, this method may involve the use of an organic solvent, the prepared microspheres cannot meet biosafety requirements, composite powder cannot be prepared, and a particle size cannot meet a 3D printing requirement. The mechanical method includes conducting high-speed and high-frequency impact or grinding on a polymer material, such that granules are continuously refined, and the polymer powder is obtained after pulverizing and sieving. Although there is no solvent involved in this method, a shape of the prepared polymer powder is irregular.

### SUMMARY

In view of this, the embodiments aim to provide a pure physical spheroidization apparatus for polymer powder, which is intended to solve a problem of irregular powder prepared by the mechanical method in the background.

To implement the foregoing objective, the present disclosure provides a pure physical spheroidization apparatus for polymer powder, including a feeding system, a spheroidization system, a circulating cooling system and a microsphere classification and collection system. The feeding system, the spheroidization system and the microsphere classification and collection system are connected in sequence.

The feeding system is configured to preheat and feed the polymer powder to the spheroidization system and includes a feeding-preheating synchronization unit, a high-speed jet powder spraying unit and a solid-gas sheath flow guide unit that are connected in sequence.

The spheroidization system is configured to melt irregular polymer powder in a flowing state through a high-temperature spheroidization and shaping technology before cooling, thereby obtaining polymer microspheres. The spheroidization system comprises a spheroidization furnace that is elongated and a cooling hopper connected to an end of the spheroidization furnace, a showerhead-shaped dispersion mechanism communicating with an outlet of the solid-gas sheath flow guide unit is suspended from a top end of the spheroidization furnace. In a temperature descending manner, the spheroidization furnace is divided into at least three segments in an axial direction of the spheroidization furnace.

The circulating cooling system is configured for temperature control and cooling of the interior of the spheroidization by employing a low-temperature fluid as a medium.

The microsphere classification and collection system is configured to classify and collect polymer microspheres by means of multistage particle classification and capture.

The microsphere classification and collection system includes a collection bin communicating with an outlet of the cooling hopper and a cyclone separation mechanism communicating with a discharge end of the collection bin.

At least two layers of sieves having different bore sizes are disposed in the collection bin for preliminary classification and collection of the polymer microspheres.

Further, an adaptive temperature control unit is disposed in the spheroidization furnace, and the adaptive temperature control unit includes a thermocouple array. Temperature sensors which are configured to monitor and feed back a temperature of each segment in real time in the spheroidization furnace by adopting the thermocouple array can dynamically adjust heating power according to a powder melting point and a fluidization requirement, thereby achieving uniformity of a temperature field and precise control of a spheroidization process.

The temperature sensors are disposed in the cooling hopper.

Further, the feeding-preheating synchronization unit includes a solid-gas mixing cylinder that is horizontally disposed, an erected powder feeding mechanism that is vertically disposed and communicates with the solid-gas mixing cylinder, a hot airflow guide mechanism for delivering a hot airflow to the solid-gas mixing cylinder and a feeding pipe for conveying a solid-gas mixture to the high-speed jet powder spraying unit.

Thermocouple sensors are disposed at a junction of the solid-gas mixing cylinder and the hot airflow guide mechanism to monitor a temperature of the hot airflow. Electric heating wires are mounted on the solid-gas mixing cylinder.

Further, the high-speed jet powder spraying unit includes a jet power device communicating with an end of the feeding pipe. A multi-hole nozzle connected with an outlet of the jet power device and a conveying pipe. An end of the conveying pipe extends to an inlet of the solid-gas sheath flow guide unit.

Further, the solid-gas sheath flow guide unit communicates with an inlet end of the spheroidization system. The solid-gas sheath flow guide unit includes a flow guide box with an upper cylindrical and lower conical structure. A feeding sprayer connected to the end of the conveying pipe is suspended from the middle of a top end of the flow guide box.

At least two guide heads that are uniformly distributed are disposed on an outer circumferential ring of the feeding sprayer, the at least two air guide heads are connected with an external fan to concentrate and gather and the polymer powder injected from the feeding sprayer towards a middle of the flow guide box.

At least two flow-stabilizing perforated plates are disposed in the flow guide box, and bore sizes of the flow-stabilizing perforated plates decrease from top to bottom in sequence.

Further, a ratio of an inner diameter of the spheroidization furnace to an inner diameter of the outlet of the cooling hopper is 5-15:1; and a length of the spheroidization furnace is not less than 3 m.

The showerhead-shaped dispersion mechanism includes a high-temperature resistant stainless steel sprayer and a micro-hole dispersion disc. A micro-hole array is configured to disperse a powder stream into fine particle clusters, thereby increasing contact area with the hot airflow. An air flow pressure is adjusted to optimize an initial distribution state of the powder within the furnace, thereby preventing agglomeration and enhancing a fluidization effect.

Further, a visual real-time monitoring apparatus is further disposed on the spheroidization furnace, which is embedded on an outer wall of an end of the spheroidization furnace; and the visual real-time monitoring apparatus includes a high-temperature-resistant optical window and a high-speed camera system.

Further, the circulating cooling system includes cooling pipes surrounding the spheroidization furnace and an outer wall of the cooling hopper, a cooling tank storing a cooling fluid, a liquid inlet mechanism for conveying the cooling fluid to the cooling pipes in different regions, and a liquid outlet pipe for discharging the cooling fluid after heat absorption.

Further, an aspect ratio of the collection bin is designed to be 2-4:1; and
the collection bin includes a bin cylinder internally provided with at least two layers of sieves having different bore sizes, and a negative pressure suction mechanism for conveying the classified and collected polymer microspheres to the cyclone separation mechanism; and bore sizes of the sieves are designed to decrease in an airflow direction.

Compared with the prior art, the embodiments have beneficial effects as follows.
1. According to the embodiments, the feeding system at a front end of the spheroidization furnace in the apparatus is configured as a composite structure including the feeding-preheating synchronization unit, the high-speed jet powder spraying unit and the solid-gas sheath flow guide unit. Through a coupling mechanism of solid-gas synergistic effect and hot air preheating, efficient transport and synchronous heating of the powder are achieved. Combined with the showerhead-shaped dispersion feeding, segmented temperature control and rapid cooling settings of a spheroidization system, the sphericity, uniformity and flowability of the polymer microspheres are effectively improved. Specifically, the sphericity is higher than 0.9, an angle of repose is less than 30°, and the particle size consistency is achieved.
2. According to the present disclosure, the apparatus is additionally provided with the circulating cooling system. Based on the principles of low-temperature fluid heat transfer and thermal equilibrium, the system can achieve precise temperature control and rapid cooling inside the entire spheroidization system with a cooling fluid as a medium, which is conducive to precise control of the spheroidization process.
3. The spheroidization furnace used in the present disclosure is suitable for a thermoplastic polymer material with a melting point below 350° C., which can be used for scale production, with production capacity ranging from 1 kg/h to 10 kg/h per unit.
4. According to the embodiments, the apparatus is applicable to a single polymer material, and can compound a functional material with the polymer to form composite polymer microsphere powder with uniformity, regularity and high sphericity.
5. According to the embodiments, the apparatus can be used for spheroidization of the polymer powder in the fields of biomedical medicine, 3D printing and chemical catalysis, with a wide application scope and excellent product effect.
6. According to the embodiments, the apparatus has no significant change in physical and chemical properties of the powder before and after spheroidization and has excellent biocompatibility.

### BRIEF DESCRIPTION OF THE DRAWINGS

FIG. 1 is a diagram of a structure of a spheroidization apparatus according to the present disclosure;

FIG. 2A-FIG. 2C are diagrams of an external perspective structure, an internal structure and a top-view structure of a flow-stabilizing perforated plate of a solid-gas sheath flow guide unit according to the present disclosure;

FIG. 3 is a diagram of an internal structure of a solid-gas mixing cylinder according to the present disclosure;

FIG. 4 is a diagram of an internal structure of a spheroidization furnace according to the present disclosure;

FIG. 5 is a diagram of an internal top-view structure of the spheroidization furnace according to the present disclosure;

FIG. 6A-FIG. 6B are diagrams of an external perspective structure of a showerhead-shaped dispersion mechanism and a micro-hole dispersion disc of a spheroidization furnace according to the present disclosure;

FIG. 7 is a diagram of an external perspective structure of a visual real-time monitoring apparatus according to the present disclosure;

FIG. 8 is a diagram of an internal top-view structure of a collection bin according to the present disclosure.

### LIST OF THE REFERENCE CHARACTERS

110 feeding-preheating synchronization unit, 111 hot airflow guide mechanism, 112 powder feeding mechanism, 113 solid-gas mixing cylinder, 114 feeding pipe, 115 electric heating wire, 116 thermocouple sensor;
120 high-speed jet powder spraying unit, 121 jet power device, 122 multi-hole nozzle, 123 conveying pipe;
130 solid-gas sheath flow guide unit, 131 feeding sprayer, 132 flow guide box, 133 air guide head, 134 flow-stabilizing perforated plate;
210 spheroidization furnace, 211 showerhead-shaped dispersion mechanism, 2111 high-temperature-resistant stainless steel sprayer, 2112 micro-hole dispersion disc, 212 heating element, 213 thermocouple array, 220 visual real-time monitoring apparatus, 221 optical window, 222 high-speed camera system, 230 cooling hopper, 231 temperature sensor;
310 cooling tank, 320 liquid inlet mechanism, 330 liquid outlet pipe, 340 cooling pipe;
410 collection bin, 411 bin cylinder, 412 sieve, 413 negative pressure suction mechanism, 420 cyclone separation mechanism.

### DETAILED DESCRIPTION OF THE EMBODIMENTS

To make the objectives, technical solutions and advantages of the present disclosure more clearly, the present disclosure is further described in detail below in conjunction with embodiments. It should be understood that the preferred embodiments described here serve only to explain the present disclosure rather than limiting the present disclosure.

### Embodiment 1

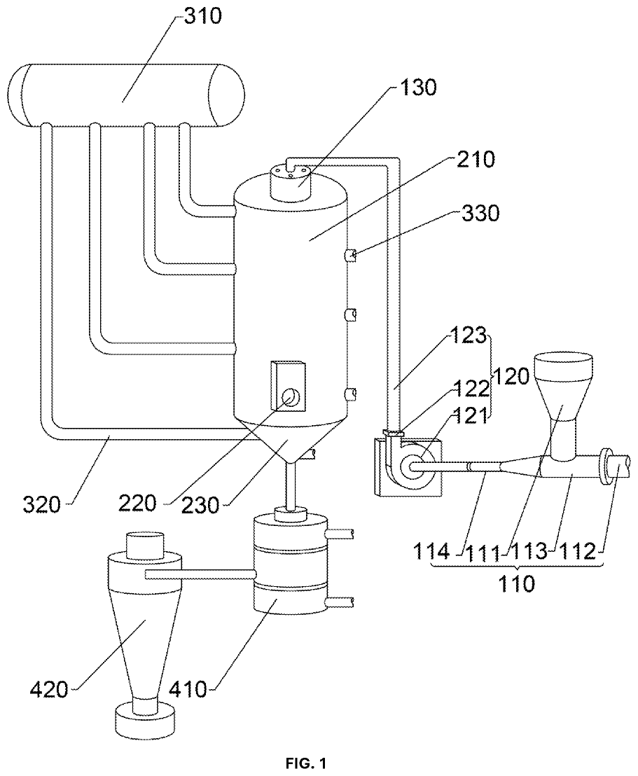

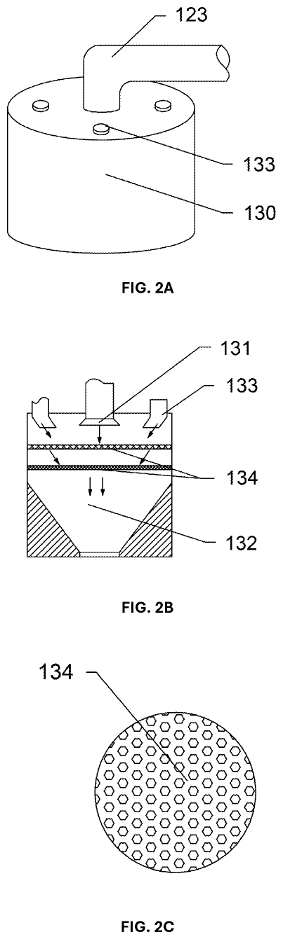

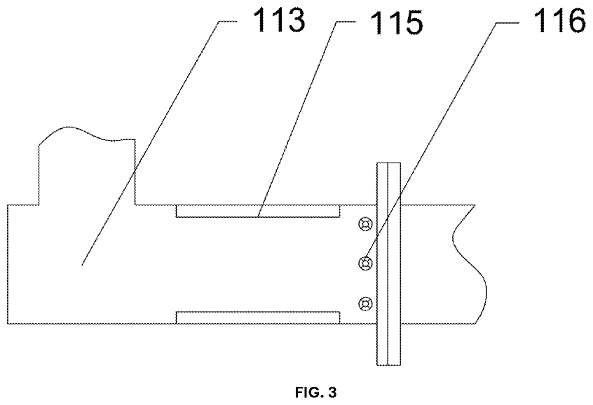

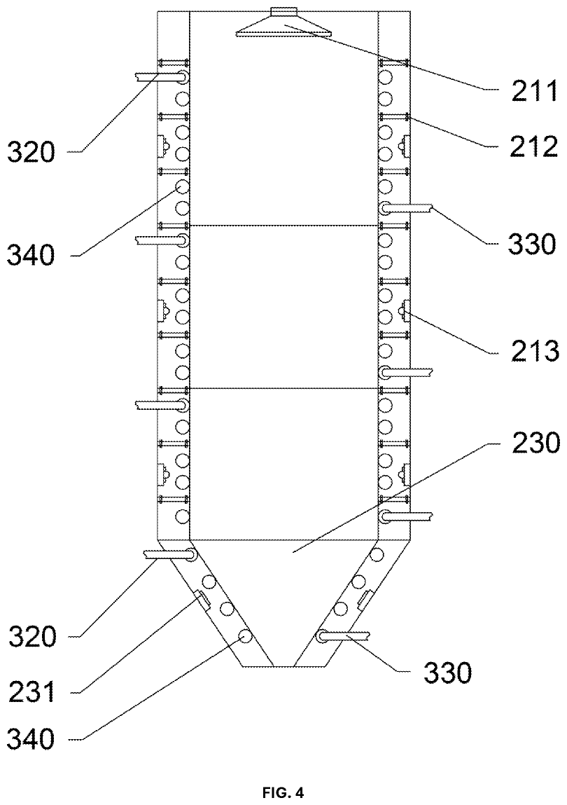

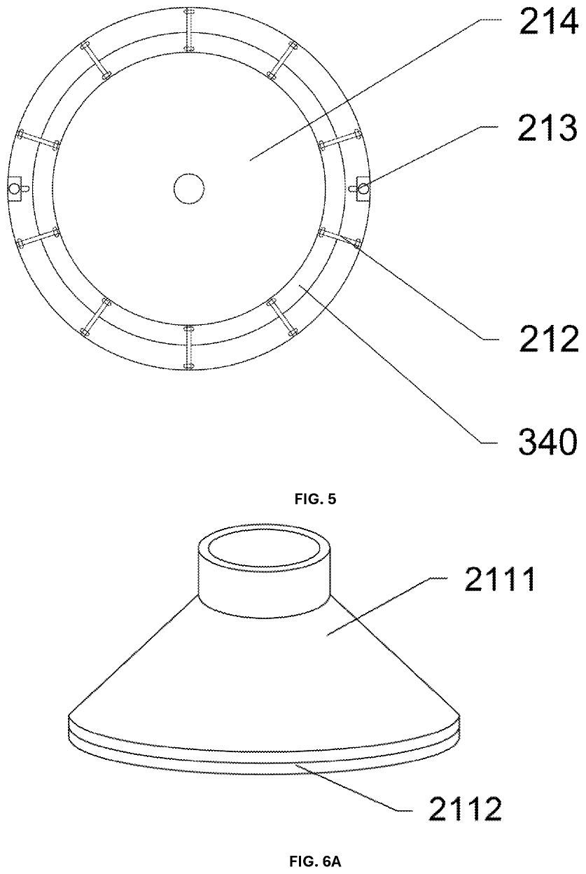

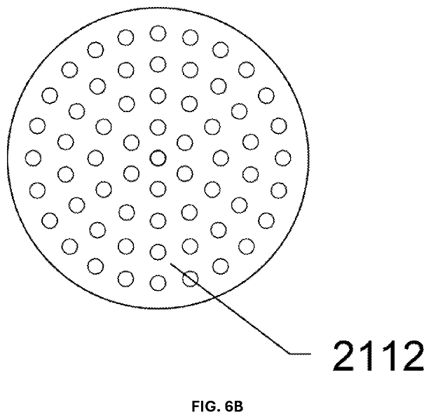

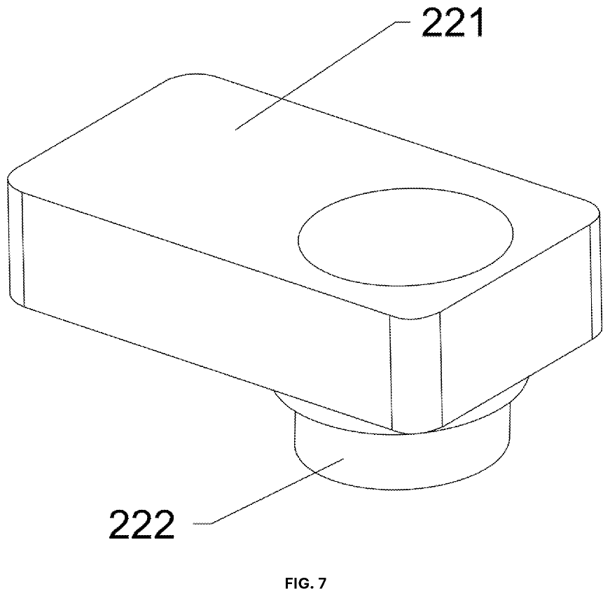

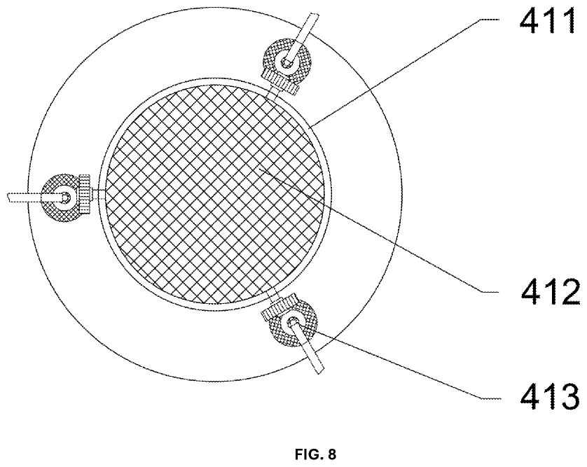

As shown in FIG. 1 to FIG. 8, a pure physical spheroidization apparatus for polymer powder, including a feeding system, a spheroidization system, a circulating cooling system and a microsphere classification and collection system.

The feeding system is configured to preheat and feed the polymer powder to the spheroidization system in a high-speed and uniform manner. The feeding system, based on the principle of particle hydrodynamics and heat conduction, can achieve efficient transport and synchronous heating of the powder through a coupling mechanism between solid-gas synergistic effect and hot air preheating. The feeding system includes a feeding-preheating synchronization unit 110, a high-speed jet powder spraying unit 120 and a solid-gas sheath flow guide unit 130 that are connected in sequence.

The function of the feeding-preheating synchronization unit 110 is to ensure that the polymer powder material is synchronously heated to a set temperature during feeding and heating uniformity is improved by using a hot airflow. The feeding-preheating synchronization unit includes a solid-gas mixing cylinder 113 that is horizontally disposed, an erected powder feeding mechanism 112 that is vertically disposed and communicates with the solid-gas mixing cylinder 113, a hot airflow guide mechanism 111 for delivering the hot airflow to the solid-gas mixing cylinder 113 and a feeding pipe 114 for conveying a solid-gas mixture to the high-speed jet powder spraying unit 120. The function of the feeding-preheating synchronization unit 110 is to achieve the coupling of feeding and preheating. A heat source for preheating is a hot airflow delivered by the hot airflow guide mechanism 111. The hot airflow guide mechanism 111 is configured to deliver the air flow at a preset temperature to the solid-gas mixing cylinder 113 by using a heater, a fan, a pipeline, a valve and the like. As a heat loss in a delivery process of the hot airflow guide mechanism 111 causes a deviation between a preheating temperature and an actual requirement, thermocouple sensors 116 are disposed at a junction of the solid-gas mixing cylinder 113 and the hot airflow guide mechanism 111 and are configured to monitor the temperature of the hot airflow. Electric heating wires 115 are mounted on the solid-gas mixing cylinder 113 to supplement the heat loss, thereby heating the hot airflow to an actually required preheating temperature. The powder feeding mechanism 112 can be adjusted according to actual requirements. If single polymer powder is used, the polymer powder can directly pass through a pump body or a conveying device. If a composite of an inorganic functional filler and a polymer material is used, the powder feeding mechanism 112 includes an extrusion mechanism and a freezing mechanism. Specifically, firstly, polymer particles and the functional filler are compounded by using a melt extrusion technology of the extrusion mechanism, and uniformly dispersed polymer particles are obtained through high-temperature melting and shearing; afterwards, then the polymer particles are processed using a cryogenic crushing method of the freezing mechanism, that is, the material is embrittled using liquid nitrogen freezing before pulverization, thereby obtaining fine-sized and irregular polymer powder.

The high-speed jet powder spraying unit 120 includes a jet power device 121 communicating with an end of the feeding pipe 114, a multi-hole nozzle 122 connected to an outlet of the jet power device 121 and a conveying pipe 123; and an end of the conveying pipe 123 extends to an inlet of the solid-gas sheath flow guide unit 130. The jet power device 121 is selected from a high-pressure centrifugal fan or an ejector, which generates a uniform high-speed jet flow through the multi-hole nozzle 122 to propel the polymer powder material for stable transport within the conveying pipe 123. The high-speed jet powder spraying unit 120 is equipped with a flow regulating valve and a pressure sensor (not marked in the figure) to accurately control an airflow speed and pressure to ensure high efficiency and consistency of the transport process.

The solid-gas sheath flow guide unit 130 communicates with an inlet end of the spheroidization system, the solid-gas sheath flow guide unit includes a flow guide box with an upper cylindrical and lower conical structure, and a feeding sprayer 131 connected to an end of the conveying pipe 123 is suspended from the middle of a top end of the flow guide box 132. At least two uniformly distributed air guide heads 133 are disposed on an outer circumferential ring of the feeding sprayer 131, the air guide heads 133 are connected to an external fan to concentrate and gather the polymer powder injected from the feeding sprayer 131 towards a middle of the flow guide box. At least two flow-stabilizing perforated plates 134 are disposed in the flow guide box 132, and bore sizes of the flow-stabilizing perforated plates 134 decrease in sequence from top to bottom. A conical design at a lower portion of the flow guide box 132, combined with an auxiliary air flow of the air guide head 133, forms a sheath flow effect capable of encapsulating and stabilizing a powder stream, thereby preventing the powder from sticking to a wall.

The spheroidization system is based on the principle of minimum energy for an incompatible system, the irregular powder is evolved into a spherical morphology with minimal surface free energy in a molten state by utilizing a high-temperature spheroidization and shaping technology under flow conditions, thereby obtaining polymer microspheres. The spheroidization system includes an elongated spheroidization furnace 210 and a cooling hopper 230 connected to an end of the spheroidization furnace 210. The spheroidization furnace 210 is made of a high-temperature-resistant ceramic composite material, and a showerhead-shaped dispersion mechanism 211 communicating with an outlet of the solid-gas sheath flow guide unit 130 is suspended from a top end of the spheroidization furnace 210. Heating elements 212 for heating the interior of the spheroidization furnace 210 are disposed in the spheroidization furnace 210. According to different temperatures, the spheroidization furnace 210 is divided into at least three segments in an axial direction of the spheroidization furnace, and a thermocouple array 213 for monitoring and feeding back temperature of each segment in real time is disposed in the spheroidization furnace 210, and temperature sensors 231 for monitoring an internal temperature are also disposed in the cooling hopper 230. The cooling hopper 230 is configured to set heating temperatures in segments based on a powder flow direction. The temperatures of the segments decrease gradually from top to bottom. The last segment serves as a heat preservation region for maintaining stability of the molten powder through radiant heating and allows the powder to gradually evolve into a spherical shape during fluidization. The molten powder completes cooling in a region of the cooling hopper 230. The present disclosure is further provided with an automatic control system which is configured to adjust an output of the heating element 213 based on the real-time temperature fed back by the thermocouple arrays 212 and actual requirements, thereby controlling an internal temperature of the spheroidization furnace 210. A ratio of an inner diameter of the spheroidization furnace 210 to an inner diameter of an outlet of the cooling hopper 230 is 5-15:1, preferably 10:1, and a length of the spheroidization furnace 210 is not less than 3 m. A size limitation of the spheroidization furnace 210 ensures residence time and heat flow coupling efficiency of the powder during fluidization, such that the powder in a molten state can be fully evolved into a spherical shape, and a spheroidization effect is improved.

The showerhead-shaped dispersion mechanism 211 includes a high-temperature-resistant stainless steel sprayer 2111 and a micro-hole dispersion disc 2112. A micro-hole array is configured to disperse a powder stream into fine particle clusters, thereby increasing contact area with the hot airflow; and an air flow pressure of the high-temperature-resistant stainless steel sprayer is adjusted to optimize an initial distribution state of the powder within the furnace, thereby preventing agglomeration and enhancing a fluidization effect.

A visual real-time monitoring apparatus 220 is further disposed on the spheroidization furnace 220, which is embedded on an outer wall of an end of the spheroidization furnace 210. The visual real-time monitoring apparatus 220 includes a high-temperature-resistant optical window 221 and a high-speed camera system 222. The optical window 221 is embedded in a sidewall of a furnace body and cooperates with an external light source and the high-speed photographing system 222 to record a morphologic evolution of the powder in a molten state in real time, thereby facilitating optimization and quality evaluation of a spheroidization process.

Based on the principles of low-temperature fluid heat transfer and thermal equilibrium, the circulating cooling system can implement precise temperature control and rapid cooling inside the entire spheroidization system by using a medium (cooling fluid) circulating cooling technology. By injecting the cooling fluid into different segmented regions of the spheroidization furnace 210 and the region of the cooling hopper 230 in a segmented manner, as well as dynamically balancing cooling capacity output, the system ensures a uniform temperature field. The thermocouple array 212 and the temperature sensor 231 are configured to record temperature distribution of the spheroidization furnace 210 and the cooling hopper 230 in real time and to control a magnitude of the output of the circulating cooling system. The circulating cooling system includes cooling pipes 340 surrounding the spheroidization furnace 210 and an outer wall the cooling hopper 230, a cooling tank 310 for storing the cooling fluid, a liquid inlet mechanism 320 for conveying the cooling fluid to the cooling pipes 340 in different regions and a liquid outlet pipe 330 for discharging the cooling fluid after heat absorption. After absorbing heat from the spheroidization furnace 210 and the cooling hopper 230, the fluid is output to an external heat sink for heat recovery and reuse. The liquid inlet mechanism 320 includes a common device such as a pipeline, a pump body and a valve, which is configured to control the start/stop, flow rate and the like of the cooling fluid conveyed by the circulating cooling system to different regions of the spheroidization furnace 210 and the cooling hopper 230. In a specific implementation process, the circulating cooling system can be activated during a spheroidization shaping operation, and a function of the circulating cooling system is to keep the interior of the spheroidization furnace 210 at a proper operating temperature. During cooling, the circulating cooling system is activated to achieve rapid cooling in the cooling hopper 230 region after spheroidization shaping. The liquid volume, liquid flow rate, liquid temperature and the like can be adjusted as required. The liquid has better heat transfer performance than the air, and the circulating cooling system can more effectively transfer heat away from the heat source to achieve rapid cooling, providing higher heat dissipation efficiency and lower noise, as well as uniform temperature distribution.

Based on the principle of solid-gas separation and particle classification, the microsphere classification and collection system can achieve efficient classification and collection of the spheroidized microspheres by using a multistage particle classification and capture technology. The microsphere classification and collection system includes a collection bin 410 communicating with an outlet of the cooling hopper 230 and a cyclone separation mechanism 420 communicating with a discharge end of the collection bin 410. An aspect ratio of the collection bin 410 is designed to be 2-4:1, preferably 3:1, thereby optimizing airflow distribution and particle settling efficiency and ensuring smooth and efficient classification and collection of the spheroidized microspheres. The collection bin 410 includes a bin cylinder 411 internally provided with at least two layers of sieves 412 having different bore sizes, and the bore sizes of the sieves 412 are adjusted according to requirements of actual target products. The polymer microspheres are preliminarily classified and collected by using the sieves 412 having different bore sizes, and then the classified and collected polymer microspheres are conveyed to the cyclone separation mechanism 420 by the negative pressure suction mechanism 413. Each layer of sieve 412 is designed such that the bore size gradually decreases in an airflow direction, and the size of the bore is adjusted according to an actual microsphere requirement. During specific implementation, the cyclone separation mechanism 420 includes a centrifugal cyclone and a collector at a bottom, small particle microspheres that meet the size requirements are separated into the collector via a high-speed rotating airflow, and a gas-sealed discharge valve is used for continuous operation and stable particle output, while large-particle microspheres are captured and processed separately.

### Embodiment 2

In this embodiment, the apparatus in Embodiment 1 is adopted to prepare polymer microspheres having a particle size ranging from 10 μm to 50 μm used in the field of medical aesthetics.

The acts of this embodiment are as follows.

In S1, the preheating temperature of the feeding-preheating synchronization unit 110 is set to be 100° C., the hot airflow guide mechanism 111 conveys the hot airflow to the solid-gas mixing cylinder 113, the thermocouple sensors 116 and the electric heating wires 115 control a temperature of the air flow entering the solid-gas mixing cylinder 113 at 100° C., irregularly L-polylactic acid particles (with a molecular weight of 120,000, a viscosity of 0.6 dL/g, a purity of 99% and a particle size range of 40 μm to 80 μm) are fed into the solid-gas mixing cylinder 113 via the powder feeding mechanism 112, and then are coupled with the hot airflow at 100° C. to form a solid-gas mixture; the solid-gas mixture is stably conveyed to the solid-gas sheath flow guide unit 130 by the high-speed jet powder spraying unit 120, and under the action of the auxiliary airflow of the air guide heads 133 and the two flow-stabilizing perforated plates 134, the L-polylactic acid particles form the sheath flow effect in the flow guide box 132 and are centrally discharged from the middle into the spheroidization system.

In S2, the preheated L-polylactic acid particles is dispersed into fine particle clusters by the showerhead-shaped dispersion mechanism 211, and the fine particle clusters enter a spheroidization furnace 210 (with the length of 7 m, and the ratio of the inner diameter of the spheroidization furnace to the inner diameter of an outlet of the material collection hopper 230 is 10:1), the spheroidization furnace 210 is divided into three different temperature regions (190° C., 170° C. and 140° C.) from top to bottom based on temperatures, and the temperature at the cooling hopper 230 region is controlled at 70° C. by the circulating cooling system (which employs cold water at 0° C. to 10° C. as a cooling fluid), and the L-polylactic acid particles fall into the cooling hopper 230 for cooling after melting within the spheroidization furnace 210, thereby forming L-polylactic acid microspheres.

In S3, the L-polylactic acid microspheres enter the collection bin 410 (with an aspect ratio of 3:1) of the microsphere classification and collection system after being discharged from the cooling hopper 230, two sieves 412 are disposed in the collection bin 410, and the bore sizes of the sieves are 50 μm and 10 μm from top to bottom. The uppermost 50 μm sieve 412 is configured to collect unqualified L-polylactic acid microspheres, which can be recycled for reprocessing, while undersized microspheres are discharged from the 10 μm sieve 412 and collected. The L-polylactic acid microspheres intercepted by the 10 μm sieve 412 are conveyed to the cyclone separation mechanism 420 by the negative pressure suction mechanism 413, and a centrifugal cyclone in the cyclone separation mechanism 420 is configured for secondary classification, and small-particle microspheres that meet a size requirement are separated and directed to the bottom collector via the high-speed rotating airflow, thereby obtaining L-polylactic acid microspheres suitable for use in the field of medical aesthetics.

The morphology of the microspheres is examined, and performance results of the microspheres processed by the cyclone separating mechanism 420 are shown in the following Table 1.

### Embodiment 3

In this embodiment, the apparatus in Embodiment 1 is adopted to prepare polymer microspheres having a particle size ranging from 10 μm to 50 μm used in the pharmaceutical field. The acts of this embodiment are as follows.

In S1, the preheating temperature of a feeding-preheating synchronization unit 110 is set to be 120° C., the hot airflow guide mechanism 111 conveys the hot airflow to the solid-gas mixing cylinder 113, the thermocouple sensors 116 and the electric heating wires 115 control the temperature of the air flow entering the solid-gas mixing cylinder 113 at 120° C., irregularly polylactic acid particles (with a molecular weight of 120,000, a viscosity of 0.6 dL/g, a purity of 99% and a particle size range of 30 μm to 50 μm) are fed into the solid-gas mixing cylinder 113 via the powder feeding mechanism 112, and then are coupled with the hot airflow at 120° C. to form a solid-gas mixture; the solid-gas mixture is stably conveyed to the solid-gas sheath flow guide unit 130 by the high-speed jet powder spraying unit 120, and under the action of the auxiliary airflow of the air guide heads 133 and two flow-stabilizing perforated plates 134, the polylactic acid particles form the sheath flow effect in the flow guide box 132 and are centrally discharged from the middle into the spheroidization system.

In S2, the preheated polylactic acid particles dispersed into fine particle clusters by the showerhead-shaped dispersion mechanism 211, and the fine particle clusters enter a spheroidization furnace 210 (with the length of 7 m, and the ratio of the inner diameter of the spheroidization furnace to the inner diameter of an outlet of the material collection hopper 230 is 10:1), the spheroidization furnace 210 is divided into three different temperature regions (200° C., 180° C. and 160° C.) from top to bottom based on temperatures, and the temperature at the cooling hopper 230 region is controlled at 80° C. by the circulating cooling system (which employs cold water at 0° C. to 10° C. as a cooling fluid), and the polylactic acid particles fall into the cooling hopper 230 for cooling after melting within the spheroidization furnace 210, thereby forming polylactic acid microspheres.

In S3, the polylactic acid microspheres enter the collection bin 410 of the microsphere classification and collection system after being discharged from the cooling hopper 230, two sieves 412 are disposed in the collection bin 410, and the bore sizes of the sieves are 10 μm and 1 μm from top to bottom. The uppermost 10 μm sieve 412 is configured to collect unqualified polylactic acid microspheres, which can be recycled for reprocessing, while undersized microspheres are discharged from the 1 μm sieve 412 and collected. The polylactic acid microspheres intercepted by the 1 μm sieve 412 are conveyed to the cyclone separation mechanism 420 by a negative pressure suction mechanism 413, and a centrifugal cyclone in the cyclone separation mechanism 420 is configured for secondary classification, and small-particle microspheres that meet a size requirement are separated and directed to the bottom collector via the high-speed rotating airflow, thereby obtaining polylactic acid microspheres suitable for use in the pharmaceutical field.

The morphology of the microspheres is examined, and the drug loading rate is determined using ultraviolet-visible spectrophotometry, which is specifically as follows: load anti-tumor drug doxorubicin on the polylactic acid microsphere in this embodiment, dissolve the drug in a proper solvent (such as dilute hydrochloric acid) to completely release the drug, determine absorbance of a sample solution by using an ultraviolet-visible spectrophotometer, and calculate the concentration and the mass of the drug according to a standard curve, thereby calculating the drug loading rate according to the following formula:

$$drug loading rate ( \% ) = \frac{100 \times mass of drug}{mass of polymer microspheres} .$$

Performance results of the microspheres processed by the cyclone separation mechanism 420 are shown in Table 1 below.

### Embodiment 4

In this embodiment, the apparatus in Embodiment 1 is adopted to prepare polymer microspheres used in the field of 3D printing, which has a particle size ranging from 20 μm to 80 μm.

The acts of this embodiment are as follows.

In S1, the preheating temperature of the feeding-preheating synchronization unit 110 is set to be 80° C., the hot airflow guide mechanism 111 conveys a hot airflow to the solid-gas mixing cylinder 113, the thermocouple sensors 116 and the electric heating wires 115 control a temperature of the air flow entering the solid-gas mixing cylinder 113 at 80° C., irregularly polylactic acid particles (with a molecular weight of 120,000, a viscosity of 0.6 dL/g, a purity of 99% and a particle size range of 100 μm to 150 μm) are fed into the solid-gas mixing cylinder 113 via the powder feeding mechanism 112, and then are coupled with the hot airflow at 80° C. to form a solid-gas mixture; the solid-gas mixture is stably conveyed to the solid-gas sheath flow guide unit 130 by the high-speed jet powder spraying unit 120, and under the action of the auxiliary airflow of the air guide heads 133 and the two flow-stabilizing perforated plates 134, the polylactic acid particles form the sheath flow effect in the flow guide box 132 and are centrally discharged from the middle into the spheroidization system.

In S2, the preheated polylactic acid particles are dispersed into fine particle clusters by the showerhead-shaped dispersion mechanism 211, and the fine particle clusters enter a spheroidization furnace 210 (with the length of 7 m, and the ratio of the inner diameter of the spheroidization furnace to the inner diameter of an outlet of the material collection hopper 230 is 10:1), the spheroidization furnace 210 is divided into three different temperature regions (180° C., 170° C. and 160° C.) from top to bottom based on temperatures, and the temperature at the cooling hopper 230 region is controlled at 70° C. by the circulating cooling system (which employs cold water at 0° C. to 10° C. as a cooling fluid), and the polylactic acid particles fall into the cooling hopper 230 for cooling after melting within the spheroidization furnace 210, thereby forming polylactic acid microspheres.

In S3, the polylactic acid microspheres enter the collection bin 410 of the microsphere classification and collection system after being discharged from the cooling hopper 230, two sieves 412 are disposed in the collection bin 410, and the bore sizes of the sieves are 80 μm and 20 μm from top to bottom. The uppermost 80 μm sieve 412 is configured to collect unqualified polylactic acid microspheres, which can be recycled for reprocessing, while undersized microspheres are discharged from the 20 μm sieve 412 and collected. The polylactic acid microspheres intercepted by the 20 μm sieve 412 are conveyed to the cyclone separation mechanism 420 by the negative pressure suction mechanism 413, and a centrifugal cyclone in the cyclone separation mechanism 420 is configured for secondary classification, and small-particle microspheres that meet a size requirement are separated and directed to the bottom collector via the high-speed rotating airflow, thereby obtaining polylactic acid microspheres suitable for use in the medical field.

The morphology of the microspheres is examined, and performance results of the microspheres processed by the cyclone separation mechanism 420 are shown in Table 1 below.

The polylactic acid microspheres prepared in this embodiment are used as the raw material to prepare a scaffold via 3D printing, which not only features a customized shape and an internal microporous structure but also exhibits high densification.

### Embodiment 5

In this embodiment, the apparatus in Embodiment 1 is adopted to prepare microspheres having a particle size ranging from 20 μm to 50 μm from an inorganic filler (silicon dioxide) and polymer powder (polylactic acid) composite material.

The acts of this embodiment are as follows.

In S1, firstly, the inorganic filler (silicon dioxide) and the polymer powder (polylactic acid) are compounded by adopting a melt extrusion technology, and polymer particles are uniformly dispersed by means of high-temperature melting and shearing and processed by using a cryogenic crushing method, and the material is embrittled by means of liquid nitrogen freezing and then pulverized to obtain fine-sized and irregular composite powder (a particle size of 80 μm to 100 μm).

In S2, the preheating temperature of the feeding-preheating synchronization unit 110 is set to be 110° C., the hot airflow guide mechanism 111 conveys the hot airflow to the solid-gas mixing cylinder 113, the thermocouple sensors 116 and the electric heating wires 115 control the temperature of the air flow entering the solid-gas mixing cylinder 113 at 110° C., the composite powder is fed into the solid-gas mixing cylinder 113 via the powder feeding mechanism 112, and then is coupled with the hot airflow at 110° C. to form a solid-gas mixture; the solid-gas mixture is stably conveyed to the solid-gas sheath flow guide unit 130 by the high-speed jet powder spraying unit 120, and under the action of the auxiliary airflow of the air guide heads 133 and two flow-stabilizing perforated plates 134, and composite particles form the sheath flow effect in the flow guide box 132 and are centrally discharged from the middle into the spheroidization system.

In S3, the composite particles are dispersed into fine particle clusters by the showerhead-shaped dispersion mechanism 211, and the fine particle clusters enter a spheroidization furnace 210 (with the length of 7 m, and the ratio of the inner diameter of the spheroidization furnace to the inner diameter of an outlet of the material collection hopper 230 is 10:1), the spheroidization furnace 210 is divided into three different temperature regions (210° C., 190° C. and 180° C.) from top to bottom based on temperatures, and the temperature at the cooling hopper 230 region is controlled at 90° C. by the circulating cooling system (which employs cold water at 0° C. to 10° C. as a cooling fluid), and the composite powder falls into the cooling hopper 230 for cooling after melting within the spheroidization furnace 210, thereby forming composite microspheres.

In S4, the composite microspheres enter the collection bin 410 of the microsphere classification and collection system after being discharged from the cooling hopper 230, three sieves 412 are disposed in the collection bin 410, and the bore sizes of the sieves are 50 μm and 20 μm from top to bottom. The uppermost 50 μm sieve 412 is configured to collect unqualified composite microspheres, which can be recycled for reprocessing, while undersized microspheres are discharged from the 20 μm sieve 412 and collected. The composite microspheres intercepted by the 20 μm sieve 412 are conveyed to the cyclone separation mechanism 420 by the negative pressure suction mechanism 413, and a centrifugal cyclone in the cyclone separation mechanism 420 is configured for secondary classification, and small-particle microspheres that meet a size requirement are separated and directed to the bottom collector via the high-speed rotating airflow, thereby obtaining composite microspheres suitable for use in the pharmaceutical field or in the field of medical aesthetics.

### Comparative Example 1

On the basis of the apparatus in Embodiment 1, a preheating structure in the solid-gas mixing cylinder 113 of the feeding system is omitted in this comparative example, which is specifically as follows: an airflow input by the hot airflow guide mechanism 111 is changed to room temperature air, and the electric heating wires 115 of the solid-gas mixing cylinder 113 are omitted. Other structures and components are consistent with that in Embodiment 1.

The apparatus in this comparative example is adopted for conducting spheroidization processing processes in Embodiment 2 to Embodiment 5, and performance of products is shown in Table 1.

In Comparative Example 1-1, a process consistent with that in Embodiment 2 is used, and a difference lies only in S1, and other acts are consistent with those in Embodiment 2. S1 in Comparative Example 1-1 is specifically as follows: the irregularly L-polylactic acid particles (with a molecular weight of 120,000, a viscosity of 0.6 dL/g, a purity of 99% and a particle size range of 40 μm to 80 μm) are fed into the solid-gas mixing cylinder 113 via the powder feeding mechanism 112, and then are coupled with the air to form a solid-gas mixture; the solid-gas mixture is stably conveyed to the solid-gas sheath flow guide unit 130 by the high-speed jet powder spraying unit 120, and under the action of the auxiliary airflow of the air guide head 133 and two flow-stabilizing perforated plates 134, the L-polylactic acid particles form the sheath flow effect in the flow guide box 132 and are centrally discharged from the middle into the spheroidization system. The properties of the final product are shown in Table 1.

In Comparative Example 1-2, a process consistent with that in Embodiment 3 is used, and a difference lies only in S1, and other acts are consistent with those in Embodiment 3. S1 in Comparative Example 1-2 is specifically as follows: the irregularly polylactic acid particles (with a molecular weight of 120,000, a viscosity of 0.6 dL/g, a purity of 99% and a particle size range of 30 μm to 50 μm) are fed into the solid-gas mixing cylinder 113 via the powder feeding mechanism 112, and then are coupled with the air to form a solid-gas mixture; the solid-gas mixture is stably conveyed to the solid-gas sheath flow guide unit 130 by the high-speed jet powder spraying unit 120, and under the action of the auxiliary airflow of the air guide head 133 and two flow-stabilizing perforated plates 134, the polylactic acid particles form the sheath flow effect in the flow guide box 132 and are centrally discharged from the middle into the spheroidization system. The properties of the final product are shown in Table 1.

In Comparative Example 1-3, a process consistent with that in Embodiment 4 is used, and a difference lies only in S1, and other acts are consistent with those in Embodiment 4. S1 in Comparative Example 1-3 is specifically as follows: the irregularly polylactic acid particles (with a molecular weight of 120,000, a viscosity of 0.6 dL/g, a purity of 99% and a particle size range of 100 μm to 150 μm) are fed into the solid-gas mixing cylinder 113 via the powder feeding mechanism 112, and then are coupled with the air to form a solid-gas mixture; the solid-gas mixture is stably conveyed to the solid-gas sheath flow guide unit 130 by the high-speed jet powder spraying unit 120, and under the action of the auxiliary airflow of the air guide head 133 and two flow-stabilizing perforated plates 134, the polylactic acid particles form the sheath flow effect in the flow guide box 132 and are centrally discharged from the middle into the spheroidization system. The properties of the final product are shown in Table 1.

In Comparative Example 1-4, a process consistent with that in Embodiment 5 is used, and a difference lies only in S2, and other acts are consistent with those in Embodiment 5. S1 in Comparative Example 1-4 is specifically as follows: the composite powder is fed into the solid-gas mixing cylinder 113 via the powder feeding mechanism 112, and then is coupled with the air to form a solid-gas mixture; the solid-gas mixture is stably conveyed to the solid-gas sheath flow guide unit 130 by the high-speed jet powder spraying unit 120, and under the action of the auxiliary airflow of the air guide head 133 and two flow-stabilizing perforated plates 134, the composite particles form the sheath flow effect in the flow guide box 132 and are centrally discharged from the middle into the spheroidization system. The properties of the final product are shown in Table 1.

### Comparative Example 2

On the basis of the apparatus in Embodiment 1, the solid-gas sheath flow guide unit 130 in the feeding system is omitted in this comparative example, and other structures and components are consistent with those in Embodiment 1.

The apparatus in this comparative example is used for conducting spheroidization processing processes in Embodiments 2 to 5, where Comparative Example 2-1 to Comparative Example 2-4 employ processes consistent with those in Embodiments 2 to 5, a merely difference is the absence of the solid-gas sheath flow guide unit 130. The properties of the final product are shown in Table 1.

### Comparative Example 3

On the basis of the apparatus in Embodiment 1, in this comparative example, the showerhead-shaped dispersion mechanism 211 in the spheroidization system is replaced with a conventional feeding mechanism, for example, a high-temperature stainless steel sprayer. Other structures and components are consistent with those in Embodiment 1.

The apparatus in this comparative example is used for conducting spheroidization processing processes in Embodiments 2 to 5, where Comparative Example 3-1 to Comparative Example 3-4 employ processes consistent with those in Embodiments 2 to 5, a merely difference is that the showerhead-shaped dispersion mechanism 211 is replaced with the high-temperature-resistant stainless steel sprayer. The properties of the final product are shown in Table 1.

TABLE 1

| | | Particle | | Drug |
|---|---|---|---|---|
| | | size | Angle of | loading |
| Test object | Sphericity | range/μm | repose/° | rate % |
| Embodiment 2 | 0.92 | 15-30 | 29 | / |
| Embodiment 3 | 0.93 | 1-10 | 29 | 55 |
| Embodiment 4 | 0.94 | 30-50 | 30 | / |
| Embodiment 5 | 0.94 | 30-40 | 28 | / |
| Comparative | 0.82 | 15-40 | 33 | / |
| Example 1-1 | | | | |
| Comparative | 0.84 | 1-10 | 35 | 47 |
| Example 1-2 | | | | |
| Comparative | 0.85 | 30-50 | 32 | / |
| Example 1-3 | | | | |
| Comparative | 0.82 | 30-40 | 34 | / |
| Example 1-4 | | | | |
| Comparative | 0.78 | 15-40 | 36 | / |
| Example 2-1 | | | | |
| Comparative | 0.78 | 1-10 | 37 | 39 |
| Example 2-2 | | | | |
| Comparative | 0.82 | 30-50 | 35 | / |
| Example 2-3 | | | | |
| Comparative | 0.79 | 30-40 | 35 | / |
| Example 2-4 | | | | |
| Comparative | 0.78 | 15-40 | 36 | / |
| Example 3-1 | | | | |
| Comparative | 0.78 | 1-10 | 37 | 39 |
| Example 3-2 | | | | |
| Comparative | 0.8 | 30-50 | 36 | / |
| Example 3-3 | | | | |
| Comparative | 0.78 | 30-40 | 36 | / |
| Example 3-4 | | | | |

It may be learned from data in Table 1 that organic microspheres or organic-inorganic composite microspheres obtained in Embodiments 2 to 5 have a controllable particle size and more uniform distribution, a spherical degree≥0.9, and an angle of repose≤30°. The physical and chemical performance of the powder before and after spheroidization does not change significantly, and the microspheres can be applied to the fields of medical aesthetics, medical, and 3D printing, and have a drug loading rate of ≥50% when applied to the biomedical field.

As can be seen from the comparison of Embodiments 2 to 5 with Comparative Example 1-1 to Embodiment 1-4 in Table 1, after the airflow input by the hot airflow guide mechanism 111 is changed to room temperature air, the microspheres have a wider particle size distribution, decreased sphericity, increased angle of repose, and reduced drug loading rate.

As can be seen from the comparison of Embodiments 2 to 5 with Comparative Example 1-1 to Embodiment 2-4 in Table 1, after the solid-gas sheath flow guide unit 130 is omitted, the prepared microspheres have greatly decreased sphericity, significantly increased angle of repose, and reduced drug loading rate.

As can be seen from the comparison of Embodiments 2 to 5 with Comparative Example 3-1 to Embodiment 3-4 in Table 1, after the showerhead-shaped dispersion mechanism 211 is replaced with the conventional feeding mechanism, the prepared microspheres have greatly decreased sphericity, significantly increased angle of repose, and reduced drug loading rate.

The foregoing embodiments only express several implementations of the present disclosure and are described more specifically and in more detail, but cannot be construed as limitations to the scope of patent of the present disclosure. It should be pointed out that several modifications and improvements can also be made by those of ordinary skill in the art without departing from the conception of the present disclosure, and all fall within the scope of protection of the present disclosure. Therefore, the scope of patent protection of the present disclosure shall be subject to the appended claims.

What is claimed is:

1. A pure physical spheroidization apparatus for polymer powder, wherein the pure physical spheroidization apparatus comprises a feeding system, a spheroidization system, a circulating cooling system and a microsphere classification and collection system; the feeding system, the spheroidization system and the microsphere classification and collection system are connected in sequence;
the feeding system is configured to preheat and feed the polymer powder to the spheroidization system and comprises a feeding-preheating synchronization unit, a high-speed jet powder spraying unit and a solid-gas sheath flow guide unit that are connected in sequence;
the spheroidization system is configured to melt irregular polymer powder in a flowing state through a high-temperature spheroidization and shaping technology before cooling, thereby obtaining polymer microspheres; and the spheroidization system comprises a spheroidization furnace that is elongated and a cooling hopper connected to an end of the spheroidization furnace; a showerhead-shaped dispersion mechanism communicating with an outlet of the solid-gas sheath flow guide unit is suspended from a top end of the spheroidization furnace; heating elements are disposed in the spheroidization furnace; and in a temperature descending manner, the spheroidization furnace is divided into at least three segments in an axial direction of the spheroidization furnace; and
the circulating cooling system is configured for temperature control and cooling of an interior of the spheroidization system by employing a low-temperature fluid as a medium.

2. The pure physical spheroidization apparatus for polymer powder according to claim 1, wherein the microsphere classification and collection system is configured to classify and collect polymer microspheres by means of multistage particle classification and capture; and
the microsphere classification and collection system comprises a collection bin communicating with an outlet of the cooling hopper and a cyclone separation mechanism communicating with a discharge end of the collection bin; and
at least two layers of sieves having different bore sizes are disposed in the collection bin for preliminary classification and collection of the polymer microspheres.

3. The pure physical spheroidization apparatus for polymer powder according to claim 1, wherein an adaptive temperature control unit is disposed in the spheroidization furnace, and the adaptive temperature control unit comprises a thermocouple array configured to monitor and feed back a temperature of each segment in real time; and
temperature sensors are disposed in the cooling hopper.

4. The pure physical spheroidization apparatus for polymer powder according to claim 1, wherein the feeding-preheating synchronization unit comprises a solid-gas mixing cylinder that is horizontally disposed, an erected powder feeding mechanism that is vertically disposed and communicates with the solid-gas mixing cylinder, a hot airflow guide mechanism for delivering a hot airflow to the solid-gas mixing cylinder and a feeding pipe for conveying a solid-gas mixture to the high-speed jet powder spraying unit; and
thermocouple sensors are disposed at a junction of the solid-gas mixing cylinder and the hot airflow guide mechanism to monitor a temperature of the hot airflow; and electric heating wires are mounted on the solid-gas mixing cylinder.

5. The pure physical spheroidization apparatus for polymer powder according to claim 4, wherein the high-speed jet powder spraying unit comprises a jet power device communicating with an end of the feeding pipe, a multi-hole nozzle connected with an outlet of the jet power device and a conveying pipe; and an end of the conveying pipe extends to an inlet of the solid-gas sheath flow guide unit.

6. The pure physical spheroidization apparatus for polymer powder according to claim 5, wherein the solid-gas sheath flow guide unit communicates with an inlet end of the spheroidization system, the solid-gas sheath flow guide unit comprises a flow guide box with an upper cylindrical and lower conical structure, and a feeding sprayer connected to an end of the conveying pipe is suspended from a middle of a top end of the flow guide box;
at least two air guide heads that are uniformly distributed are disposed on an outer circumferential ring of the feeding sprayer, the at least two air guide heads are connected with an external fan to concentrate and gather the polymer powder injected from the feeding sprayer towards a middle of the flow guide box; and
at least two flow-stabilizing perforated plates are disposed in the flow guide box, and bore sizes of the flow-stabilizing perforated plates decrease from top to bottom in sequence.

7. The pure physical spheroidization apparatus for polymer powder according to claim 1, wherein a ratio of an inner diameter of the spheroidization furnace to an inner diameter of the outlet of the cooling hopper is 5-15:1; and a length of the spheroidization furnace is not less than 3 m; and
the showerhead-shaped dispersion mechanism comprises a high-temperature resistant stainless steel sprayer and a micro-hole dispersion disc.

8. The pure physical spheroidization apparatus for polymer powder according to claim 1, wherein a visual real-time monitoring apparatus is further disposed on the spheroidization furnace and is embedded on an outer wall of an end of the spheroidization furnace; and the visual real-time monitoring apparatus comprises a high-temperature-resistant optical window and a high-speed camera system.

9. The pure physical spheroidization apparatus for polymer powder according to claim 1, wherein the circulating cooling system comprises cooling pipes surrounding the spheroidization furnace and an outer wall of the cooling hopper, a cooling tank storing a cooling fluid, a liquid inlet mechanism for conveying the cooling fluid to the cooling pipes in different regions, and a liquid outlet pipe for discharging the cooling fluid after heat absorption.

10. The pure physical spheroidization apparatus for polymer powder according to claim 2, wherein an aspect ratio of the collection bin is 2-4:1; and
the collection bin comprises a bin cylinder internally provided with at least two layers of sieves having different bore sizes, and a negative pressure suction mechanism for conveying the classified and collected polymer microspheres to the cyclone separation mechanism; and bore sizes of the sieves are designed to decrease in an airflow direction.
